(19) United States
(12) Patent Application Publication
(10) Pub. No.: US 2025/0333858 A1
(43) Pub. Date: Oct. 30, 2025

(54) HIGH PRESSURE GASKET FOR AN ELECTROLYSIS DEVICE

(71) Applicant: Tenneco Inc, Northville, MI (US)

(72) Inventors: Joshua Merillat, Plymouth, MI (US); Brent Sedlar, Dexter, MI (US); Roland Pakozdi, Nyul (HU)

(21) Appl. No.: 18/649,652

(22) Filed: Apr. 29, 2024

(51) Int. Cl. C25B 9/60; C25B 1/04

(52) U.S. Cl. CPC C25B 9/60; C25B 1/04

(57) ABSTRACT

The electrolysis device includes a plurality of plates that have a plurality of sets of aligned fluid openings. At least one of the sets of aligned fluid openings is configured for conveying high pressure hydrogen gas. At least one gasket, which has an annular shape and is made of an elastomeric material, surrounds at least one of the sets of aligned fluid openings to establish a fluid-tight seal between at least two of the plurality of plates. The at least one gasket has a generally constant cross-sectional shape around a central axis, the cross-sectional shape having a sealing surface that includes a pair of peaks that are spaced radially apart from one another and that includes a pair of elevated plateaus on opposite radial sides of the pair of peaks.

The present disclosure is related generally to gaskets and, more particularly, to the types of gaskets that operate at very high pressure, such as gaskets in an electrolysis device.

### 2. RELATED ART

An electrolysis device is a machine that uses electricity, which may be produced by a renewable resource such as solar panels or by any suitable source, to split water into its constituents, i.e., hydrogen and oxygen. The hydrogen that is produced by the electrolysis device can then be stored for later use. For example, the stored hydrogen can be used to produce electricity in a fuel cell. The hydrogen is typically stored at very high pressures, e.g., greater than five hundred and fifty pounds per square inch (550 psi). These very high pressures can be either achieved within the electrolysis device, such that the electrolysis device directly outputs high pressure hydrogen, or the hydrogen can be exhausted from the electrolysis device at a low pressure and then compressed to the high pressures after it has left the electrolysis device.

For designs where the electrolysis device compresses the hydrogen to very high pressure before outputting the hydrogen, there remains a need for a low cost and reliable gasket that is effective at sealing components within the electrolysis device against these high pressures.

### SUMMARY

One aspect of the present disclosure is related to an electrolysis assembly. The electrolysis assembly includes a plurality of plates that have a plurality of sets of aligned fluid openings. At least one of the sets of aligned fluid openings is configured for conveying high pressure hydrogen gas. At least one gasket, which has an annular shape and is made of an elastomeric material, surrounds at least one of the sets of aligned fluid openings to establish a fluid-tight seal between at least two of the plurality of plates. The at least one gasket has a generally constant cross-sectional shape around a central axis, the cross-sectional shape having a sealing surface that includes a pair of peaks that are spaced radially apart from one another and that includes a pair of elevated plateaus on opposite radial sides of the pair of peaks.

According to another aspect of the present disclosure, the at least one gasket includes a plurality of gaskets that have the same cross-sectional shape.

According to yet another aspect of the present disclosure, at least one of the plates is a bi-polar plate that is made of metal.

According to still another aspect of the present disclosure, at least one of the plates is an insulator plate that is made of plastic, and the at least one gasket seals the bi-polar plate with the insulator plate.

According to a further aspect of the present disclosure, the at least one gasket includes a plurality of gaskets that surround each of the sets of aligned fluid openings. Some of the plurality of gaskets have different outer diameters.

According to yet a further aspect of the present disclosure, at least one gasket of the plurality of gaskets surrounds a plurality of the other gaskets of the plurality of gaskets.

According to still a further aspect of the present disclosure, at least one plate of the plurality of plates includes a through-passage and wherein the at least one gasket includes two gaskets that are monolithic with one another and are attached together through the through-passage.

According to another aspect of the present disclosure, the cross-sectional shape of the at least one gasket further includes a pair of recessed shoulders on opposite radial sides of the pair of elevated plateaus.

According to yet another aspect of the present disclosure, the peaks directly contact and are sealed against one of the plurality of plates and the elevated plateaus do not directly contact the one of the plurality of plates.

According to still another aspect of the present disclosure, the peaks and the elevated plateaus directly contact and are sealed against one of the plurality of plates.

Another aspect of the present disclosure is related to an electrolysis unit. The electrolysis unit includes a bi-polar plate, an insulator plate, an anode, a cathode, and a gas-diffusion layer. The bi-polar plate and the insulator plate have a plurality of sets of aligned fluid openings. The electrolysis unit also includes at least one gasket that has an annular shape and is made of an elastomeric material. The at least one gasket surrounds at least one of the sets of aligned fluid openings to establish a fluid-tight seal between the bi-polar plate and the insulator plate. The at least one gasket has a generally constant cross-sectional shape around a central axis. The cross-sectional shape has a sealing surface that includes a pair of peaks that are spaced radially apart from one another. The cross-sectional shape also includes a pair of elevated plateaus on opposite radial sides of the pair of peaks.

According to another aspect of the present disclosure, the at least one gasket includes a plurality of gaskets that have the same cross-sectional shape.

According to yet another aspect of the present disclosure, the at least one gasket includes a plurality of gaskets that surround each of the sets of aligned fluid openings. Some of the plurality of gaskets have different outer diameters.

According to still another aspect of the present disclosure, at least one gasket of the plurality of gaskets surrounds a plurality of the other gaskets of the plurality of gaskets.

According to a further aspect of the present disclosure, the peaks directly contact and are sealed against the insulator plate and the elevated plateaus do not directly contact the insulator plate.

According to yet a further aspect of the present disclosure, the peaks and the elevated plateaus directly contact and are sealed against the insulator plate.

Yet another aspect of the present disclosure is related to a hydrogen production device that includes a plurality of electrolysis stacks that are configured to receive water and electricity and output high-pressure hydrogen gas and oxygen gas. Each of the electrolysis stacks includes a plurality of electrolysis units. At least one of the electrolysis units has a bi-polar plate, an insulator plate, an anode, a cathode, and a gas-diffusion layer. The bi-polar plate and the insulator plate have a plurality of sets of aligned fluid openings. Each of the electrolysis units also has at least one gasket that has an annular shape and is made of an elastomeric material. The at least one gasket surrounds at least one of the sets of aligned fluid openings to establish a fluid-tight seal between the bi-polar plate and the insulator plate. The at least one gasket has a generally constant cross-sectional shape around a central axis. The cross-sectional shape has a sealing surface that includes a pair of peaks that are spaced radially apart from one another and that includes a pair of elevated plateaus, which are located on opposite radial sides of the pair of peaks.

According to another aspect of the present disclosure, the at least one gasket includes a plurality of gaskets that have the same cross-sectional shape.

According to yet another aspect of the present disclosure, the peaks directly contact and are sealed against the insulator plate and the elevated plateaus do not directly contact the insulator plate.

According to still another aspect of the present disclosure, the peaks and the elevated plateaus directly contact and are sealed against the insulator plate.

### BRIEF DESCRIPTION OF THE DRAWINGS

These and other features and advantages of the invention will become more readily appreciated when considered in connection with the following description of the presently preferred embodiments, appended claims and accompanying drawings, in which:

FIG. 1 is an example embodiment of a hydrogen production device for converting water into gaseous hydrogen and oxygen;

FIG. 2 is an exploded view of an example embodiment of an electrolysis unit;

FIG. 3 is a front view of an exemplary embodiment of a bi-polar plate for the electrolysis unit of FIG. 2 and including a plurality of gaskets;

FIG. 4 is a back view of the exemplary embodiment of a bi-polar plate for the electrolysis unit of FIG. 2 and including the plurality of gaskets;

FIG. 5 is a cross-sectional view of a portion of the bi-polar plate of FIGS. 3 and 4;

FIG. 6 is a cross-sectional view of another portion of the bi-polar plate of FIGS. 3 and 4;

FIG. 7 is an enlarged view of a portion of the bi-polar plate of FIGS. 3 and 4;

FIG. 8 is a front view of the bi-polar plate of FIGS. 3 and 4 and without the plurality of gaskets;

FIG. 9 is a cross-sectional view of one of the gaskets between a bi-polar plate and an insulator plate and in a resting (unstressed) condition;

FIG. 10 is a cross-sectional view of the gasket of FIG. 9 and in a least material condition and compressed between the bi-polar plate and the insulator plate;

FIG. 11 is a cross-sectional view of the gasket of FIG. 9 and in a most material condition and compressed between the bi-polar plate and the insulator plate; and

FIG. 12 is a cross-sectional view of a second exemplary embodiment of the gasket.

### DESCRIPTION OF THE ENABLING EMBODIMENT

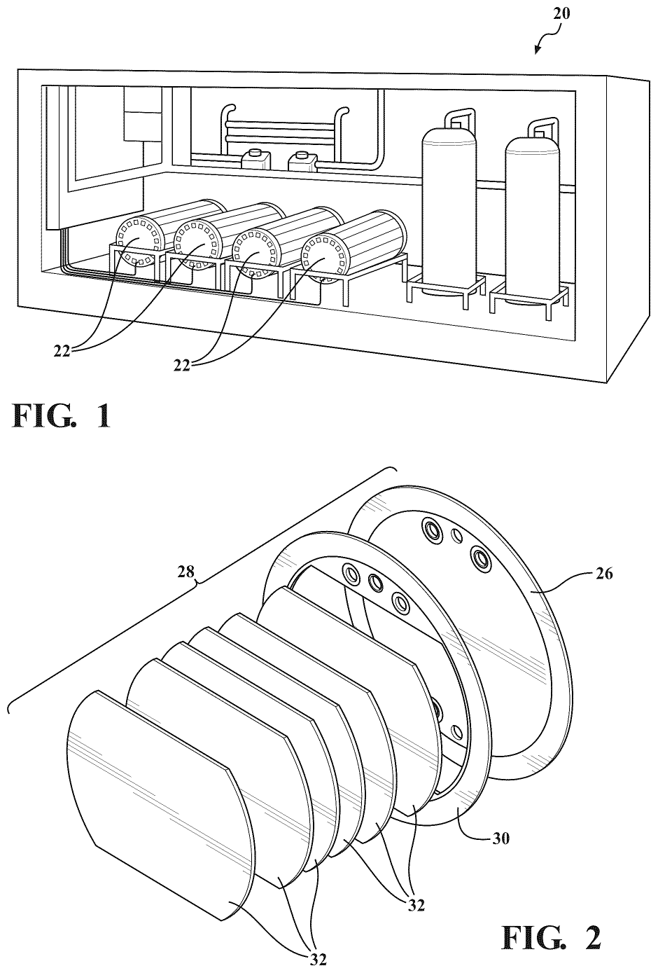

Referring to the Figures, wherein like numerals indicate corresponding parts throughout the several views, one aspect of the present disclosure is related to an improved electrolysis machine that includes a plurality of gaskets that seal components together in the electrolysis machine together. As discussed in further detail below, the gaskets made of an elastomeric material and are functional at pressures of up to five hundred and fifty pounds per square inch (550 psi). FIG. 1 illustrates an example hydrogen production and storage unit 20 that includes four example electrolysis stacks 22 for separating a water into its constituents, i.e., oxygen and hydrogen. The four electrolysis stacks 22 are in fluid communication with a pair of high-pressure storage tanks 24 and supply the storage tanks 24 with high-pressure hydrogen that is produced within the electrolysis stacks 22.

Turning now to FIG. 2, each of the electrolysis stacks includes a plurality bi-polar plates 26 (one of which is illustrated) that are made of metal and separate a plurality of electrolysis units 28 that make up the electrolysis stack. Some electrolysis stacks can include up to two-hundred electrolysis units 28. Between two bi-polar plates 26, each electrolysis unit 28 includes an insulator plate 30 and electrolysis layers 32 (e.g., cathodes, anodes, gas diffusion layers, membranes, etc.). In operation, water is fed into the electrolysis unit 28 and the anodes and cathodes are electrically energized, thereby creating a chemical reaction that breaks the water molecules apart to produce both hydrogen gas, which is sent to the high-pressure storage tanks, and oxygen gas. The electrolysis stack also includes a plurality of gasket assemblies that seal the bipolar plates 26 with the insulator plates 30 and that are able to maintain those seals in the presence of high-pressure fluids (specifically, hydrogen and oxygen) within the electrolysis stack.

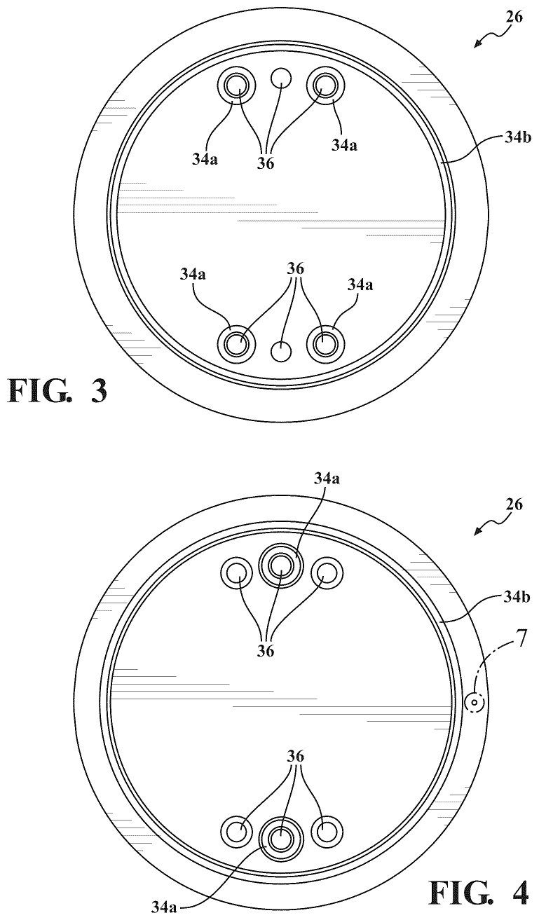

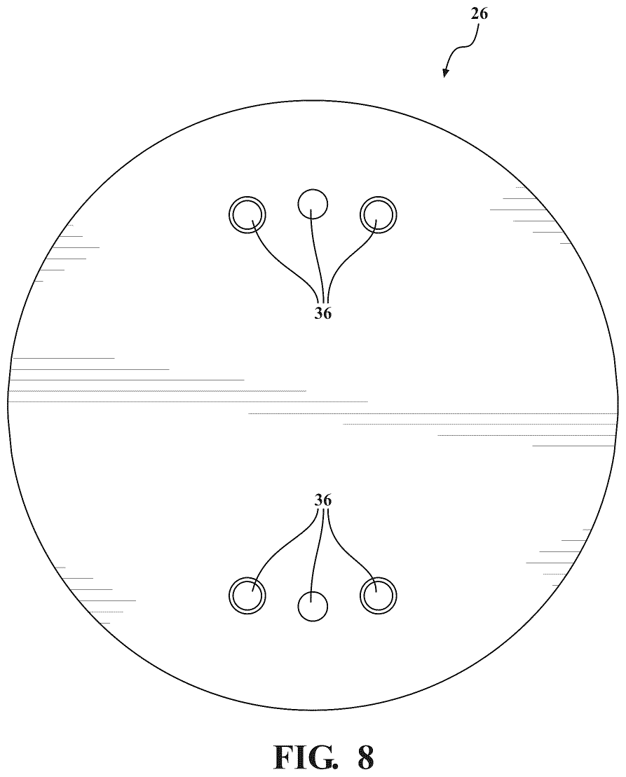

FIGS. 3-7 illustrate an exemplary embodiment of the gasket assembly for establishing the fluid-tight seal between the bi-polar plate 26 and the insulator plate 30 in the electrolysis stack 22. The gasket assembly includes a plurality of annular gaskets 34 that are disposed on the bi-polar plate 26. As illustrated in FIG. 8, the bi-polar plate 26 is generally planar in construction and is preferably made of a metallic material that is resistant to deformation when exposed to high pressures. For example, in some embodiments, the bi-polar plate 26 is made of 316L stainless steel, which is sometimes also known as A4 stainless steel or marine grade stainless steel. The insulator plate 30, in contrast, is made of a plastic material. In some alternate embodiments, the insulator plate and bi-polar plate can be combined together and the gaskets can seal two combination insulator/bi-polar plates together.

In the exemplary embodiment, eight total gaskets 34a, 34b that are disposed on the bi-polar plate 26 for establishing fluid tight seals between the bi-polar plate 26 and the insulator plate 30. In this example embodiment, five of the gaskets 34a, 34b are located on one side of the bi-polar plate 26 and three of the gaskets 34a, 34b are located on an opposite side of the bi-polar plate 26. As discussed in further detail below, due to the unique cross-sectional shape that the inner and outer gaskets 34a, 34b have in common, they are able to withstand the high-pressures of the fluids in the electrolysis stack even while being made of an elastomeric material, such as rubber or a rubber-like material. This is in contrast to other gasket designs, which typically require the gasket to be made of metal to resist such high-pressure fluids. The unique cross-sectional shape of the inner and outer gaskets 34a, 34b allows the gaskets 34a, 34b of the present disclosure to both be made of an elastomeric material and also seal such high-pressure fluids is discussed in further detail below. This cross-sectional shape is generally constant three-hundred and sixty degrees around a central axis of the respective gasket 34a, 34b.

Referring now to FIG. 8, the bi-polar plate 26 is generally symmetrical about a vertical plane (with reference to the orientation of the carrier layer in this figure). The bi-polar plate 26 includes six fluid openings 36 with three fluid openings 36 being positioned on each side of the vertical plane. In operation, the fluid openings 36 convey the hydrogen gas, the water, and the oxygen gas through the electrolysis stack. The outer periphery of the bi-polar plate 26 is generally circular.

The plurality of gaskets 34a, 34b include six inner gaskets 34a that surround each of the six fluid openings 36 in the bi-polar plate 26 with each fluid opening 36 being surrounded by a single inner gasket 34a on one side of the bi-polar plate 26. In this example embodiment, four of the inner gaskets 34a are disposed on one side of the bi-polar plate 26 and the other two inner gaskets 34a are disposed on an opposite side of the bi-polar plate 26. When the electrolyte stack is assembled and tightened, the inner gaskets 34a are sandwiched between one of the bi-polar plates 26 and one of the insulator plates 30 and press against these components to establish the fluid-tight seals so that the fluids flowing through the fluid openings 36 cannot escape their respective flow passages.

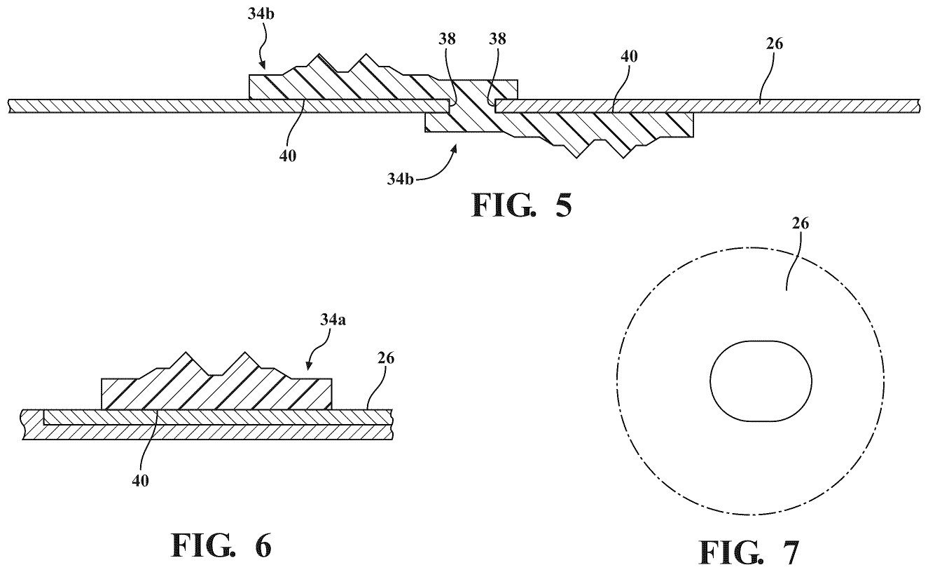

Additionally, a pair of outer gaskets 34b surround the entire central area of the bi-polar plate 26 with one of the outer gaskets 34b being positioned on each side of the bi-polar plate 26. The outer gaskets 34b provide an additional fluid-tight seal to capture any fluids that might leak past any of the inner gaskets 34a so that those fluids cannot escape the electrolysis stack. As illustrated in FIG. 5, the bi-polar plate 26 includes a plurality of through-passages 38, and the elastomeric material of the outer gaskets 34b extends through these through-passages 38 such that the two outer gaskets 34b are formed as a monolithic piece of material in a single over-molding process. In the exemplary embodiment, one of the outer gaskets 34b has a larger diameter than the other outer gasket 34b, i.e., the outer gaskets 34b do not fully overlap with one another.

In the exemplary embodiment, all of the inner and outer gaskets 34a, 34b are overmolded into connection with the bi-polar plate 26. In the exemplary embodiment, the inner and outer gaskets 34a, 34b are made of EPDM E93 sheeting with a 70 Shore A hardness.

As illustrated in FIGS. 5 and 6, the inner gaskets 34a and the outer gaskets 34b have approximately the same cross-sectional shape, which has been optimized for performance in the high-pressure environment of the electrolysis stack, i.e., to seal hydrogen and oxygen gasses at pressures of up to five hundred and fifty pounds per square inch (550 psi). More specifically, each of the gaskets 34a, 34b has a cross-sectional shape includes a generally flat first surface 40, which contacts and seals against the bi-polar plate 26, and a precisely shaped second surface that is configured to optimize the seal that's established with the insulator plate 30.

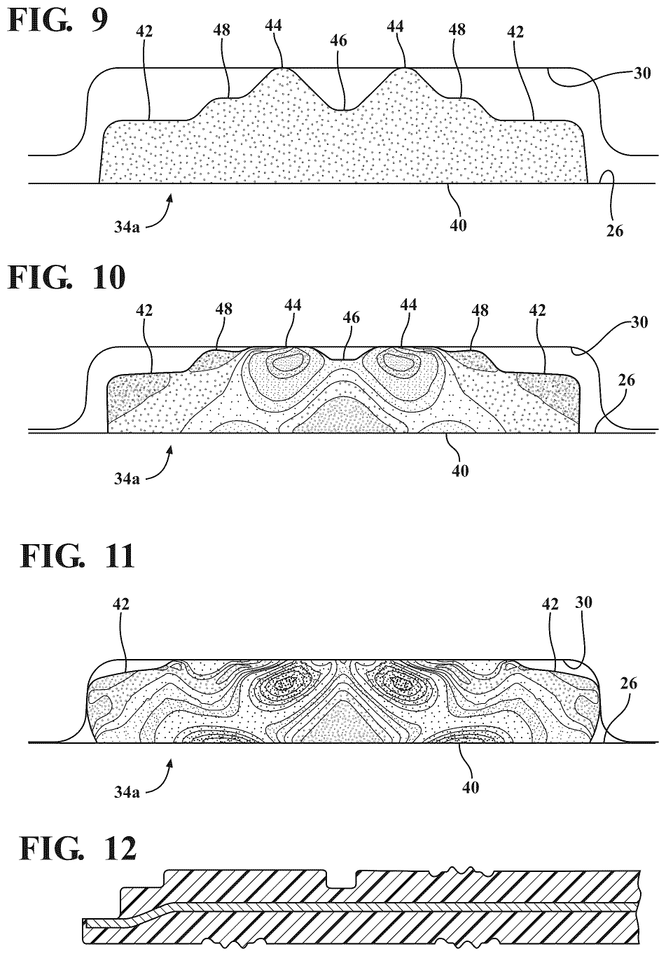

The second surface of one of the inner gaskets 34a is shown in a resting (unstressed) condition in FIG. 9, i.e., prior to tightening the electrolyte stack and compressing the inner gasket 34a between the insulator plate 26 and the bi-polar plate 30. While FIG. 9 illustrates one of the inner gaskets 34a, it should be appreciated that the second surfaces of the outer gaskets 34b are similarly constructed and behave similarly when compressed between the bi-polar plate 26 and the insulator plate 30 as discussed below.

The second surface, which seals against the insulator plate 30, includes a pair of recessed shoulders 42 that are located on opposite radial sides of the second surface. The second surface also includes a pair of projections or peaks 44 in a generally central area of the second surface in the radial direction and that project away from the bi-polar plate 26. The peaks 44 are separated from one another by a deep valley 46 that is only slightly elevated relative to the recessed shoulders 42. In the exemplary embodiment, the peaks 44 are approximately two millimeters (2 mm) apart from one another from the summit of one peak 44 to the summit of the other peak 44. In between each peak 44 and the associated recessed shoulder 42, the second surface includes an elevated plateau 48. Thus, there are two plateaus 48, one on either side of the twin peaks 44 of the second surface.

In the exemplary embodiment, the gaskets 34a, 34b each have a width (measured radially from the end of one recessed shoulder 42 to the opposite end of the other) to maximum height ratio (measured from the first surface 40 to the summit of each of the peaks 44) of greater than eight to one (8:1). The gaskets 34a, 34b each also have a thickness of approximately one millimeter (1 mm) at each of the recessed shoulders 42 and a thickness of approximately two millimeters (2 mm) at each of the peaks 44.

FIGS. 10 and 11 illustrate one of the inner gaskets 34a being compressed between the bi-polar plate 26 and the insulator plate 30 in two possible conditions: a least material condition (LMC, FIG. 10) and a most material condition (MMC, FIG. 11). The least material condition and the most material condition define the shape and size of the inner gasket 34a throughout the acceptable range of tolerances. Although not illustrated, the same is true for the outer gaskets 34b as well.

As illustrated in FIG. 10, in the least material condition, only the peaks 44 (illustrated in FIG. 9) are compressed and the elevated plateaus 48 do not contact the insulator plate 30. However, there still are two spaced apart sealing areas where the gasket 34a directly contacts the insulator plate 30. This condition has been found to be sufficiently strong to maintain fluid-tight seals and resist damage when exposed to the high-pressure fluids in the electrolysis stack.

Turning now to the most material condition of FIG. 11, in this condition, due to the increased thickness of the gasket 34a, the peaks have been compressed by a greater degree and flattened such that the plateaus also engage the insulator plate 30. Further, the radial ends of the recessed shoulders 42 have become deformed and also press directly against an annular recess in the insulator plate 30 to further seal the inner gasket 34a against the insulator plate 30. Thus, in the most material condition, there are three spaced apart areas of direct contact between the gasket 34a and the insulator plate 30. This has also been found to establish a fluid-tight seal and resist damage when exposed to the high-pressure fluids in the electrolysis stack.

In both of the least material condition and the most material condition, when the gasket 34a, 34b is compressed, the Von Mises stress is less than the ultimate tensile strength of the material that the gasket 34a, 34b is made of. Thus, neither condition presents a risk of crack formation. In other words, throughout the range of tolerances, the inner and outer gaskets 34a, 34b can perform the job of sealing high-pressure fluids in the electrolysis stack without damage. The unique shape of the gaskets 34a, 34b has also been found to increase the range of tolerances (i.e., a greater difference between the least material condition and the most material condition), thereby allowing the inner and outer gaskets 34a, 34b to be constructed more cost efficiently. Costs are further reduced through economies of scale since the inner and outer gaskets 34a, 34b share the same cross-sectional shape.

Turning now to FIG. 12, a second exemplary embodiment of a gasket assembly is illustrated with like numerals, separated by a prefix of “1,” identifying similar components with the embodiment described above. In the second embodiment, the bi-polar plate 126 is substantially encapsulated with a rubber material on both sides of the bi-polar plate 126. The gaskets 134a, 134b are made as one piece with the rubber material on both sides of the bi-polar plate 126. As illustrated, the gaskets 134a, 134b have the same cross-sectional shapes as the gaskets 34a, 34b of the embodiment described above. That is, the gaskets 134a, 134b also have spaced apart peaks, which project above a top surface of the surrounding rubber material, and elevated plateaus.

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other.

What is claimed is:

1. An electrolysis assembly, comprising:
a plurality of plates that have a plurality of sets of aligned fluid openings, at least one of the sets of aligned fluid openings being configured for conveying high pressure hydrogen gas;
at least one gasket that has an annular shape and is made of an elastomeric material and that surrounds at least one of the sets of aligned fluid openings to establish a fluid-tight seal between at least two of the plurality of plates; and
the at least one gasket having a generally constant cross-sectional shape around a central axis, the cross-sectional shape having a sealing surface that includes a pair of peaks that are spaced radially apart from one another and that includes a pair of elevated plateaus on opposite radial sides of the pair of peaks.

2. The electrolysis assembly as set forth in claim 1, wherein the at least one gasket includes a plurality of gaskets that have the same cross-sectional shape.

3. The electrolysis assembly as set forth in claim 1, wherein at least one of the plates is a bi-polar plate that is made of metal.

4. The electrolysis assembly as set forth in claim 3, wherein at least one of the plates is an insulator plate that is made of plastic, and wherein the at least one gasket seals the bi-polar plate with the insulator plate.

5. The electrolysis assembly as set forth in claim 4, wherein the at least one gasket includes a plurality of gaskets that surround each of the sets of aligned fluid openings, and wherein some of the plurality of gaskets have different outer diameters.

6. The electrolysis assembly as set forth in claim 5, wherein at least one gasket of the plurality of gaskets surrounds a plurality of the other gaskets of the plurality of gaskets.

7. The electrolysis assembly as set forth in claim 1, wherein at least one plate of the plurality of plates includes a through-passage and wherein the at least one gasket includes two gaskets that are monolithic with one another and are attached together through the through-passage.

8. The electrolysis assembly as set forth in claim 1, wherein the peaks directly contact and are sealed against one of the plurality of plates and the elevated plateaus do not contact the one of the plurality of plates.

9. The electrolysis assembly as set forth in claim 1, wherein the peaks and the elevated plateaus directly contact and are sealed against one of the plurality of plates.

10. The electrolysis assembly as set forth in claim 1, wherein the cross-sectional shape of the at least one gasket further includes a pair of recessed shoulders on opposite radial sides of the pair of elevated plateaus.

11. An electrolysis unit, comprising:
a bi-polar plate, an insulator plate, an anode, a cathode, and a gas-diffusion layer;
the bi-polar plate and the insulator plate having a plurality of sets of aligned fluid openings;
at least one gasket that has an annular shape and is made of an elastomeric material and that surrounds at least one of the sets of aligned fluid openings to establish a fluid-tight seal between the bi-polar plate and the insulator plate; and
the at least one gasket having a generally constant cross-sectional shape around a central axis, the cross-sectional shape having a sealing surface that includes a pair of peaks that are spaced radially apart from one another and that includes a pair of elevated plateaus on opposite radial sides of the pair of peaks.

12. The electrolysis unit as set forth in claim 11, wherein the at least one gasket includes a plurality of gaskets that have the same cross-sectional shape.

13. The electrolysis unit as set forth in claim 11, wherein the at least one gasket includes a plurality of gaskets that surround each of the sets of aligned fluid openings and wherein some of the plurality of gaskets have different outer diameters.

14. The electrolysis unit as set forth in claim 13, wherein at least one gasket of the plurality of gaskets surrounds a plurality of the other gaskets of the plurality of gaskets.

15. The electrolysis unit as set forth in claim 11, wherein the peaks directly contact and are sealed against the insulator plate and the elevated plateaus do not directly contact the insulator plate.

16. The electrolysis unit as set forth in claim 11, wherein the peaks and the elevated plateaus directly contact and are sealed against the insulator plate.

17. A hydrogen production device, comprising:
a plurality of electrolysis stacks that are configured to receive water and electricity and output high-pressure hydrogen gas and oxygen gas;
each of the electrolysis stacks including a plurality of electrolysis units;
at least one of the electrolysis units comprising;
a bi-polar plate, an insulator plate, an anode, a cathode, and a gas-diffusion layer;
the bi-polar plate and the insulator plate having a plurality of sets of aligned fluid openings;
at least one gasket that has an annular shape and is made of an elastomeric material and that surrounds at least one of the sets of aligned fluid openings to establish a fluid-tight seal between the bi-polar plate and the insulator plate; and
the at least one gasket having a generally constant cross-sectional shape around a central axis, the cross-sectional shape having a sealing surface that includes a pair of peaks that are spaced radially apart from one another and that includes a pair of elevated plateaus on opposite radial sides of the pair of peaks.

18. The hydrogen production device as set forth in claim 17, wherein the at least one gasket includes a plurality of gaskets that have the same cross-sectional shape.

19. The hydrogen production device as set forth in claim 17, wherein the peaks directly contact and are sealed against the insulator plate and the elevated plateaus do not directly contact the insulator plate.

20. The electrolysis unit as set forth in claim 17, wherein the peaks and the elevated plateaus directly contact and are sealed against the insulator plate.
